(19) United States
(12) Patent Application Publication
(10) Pub. No.: US 2008/0294291 A1
(43) Pub. Date: Nov. 27, 2008

(54) BUILDING AUTOMATION SYSTEMS AND METHODS FOR CONTROLLING INTERACTING CONTROL LOOPS

(75) Inventor: Timothy Salsbury, Whitefish Bay, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/125,843

(22) Filed: May 22, 2008

Related U.S. Application Data
(60) Provisional application No. 60/940,007, filed on May 24, 2007.

(51) Int. Cl. G01M 1/38

(52) U.S. Cl. 700/277

(57) ABSTRACT

A method for maintaining a first climate control setpoint for a first building zone having an environment that is effected by a second building zone's environment includes the steps of providing the first climate control setpoint to a first control loop configured to control the environment of the first building zone. The method further includes providing a second climate control setpoint to a second control loop configured to control the environment of the second building zone. The method yet further includes receiving information about the actual climate of the first building zone and the actual climate of the second building zone; and modifying the first climate control setpoint and the second climate control setpoint to compensate for interaction between the first control loop and the second control loop.

### CROSS-REFERENCE TO RELATED APPLICATIONS

The present application claims the benefit of U.S. Provisional Patent Application No. 60/940,007, filed May 24, 2007, the entire disclosure of which is incorporated by reference in its entirety.

### BACKGROUND

The present disclosure generally relates to the field of building automation system and methods. The present disclosure relates more specifically to controlling multiple control loops to minimize interactions between the loops for building automation systems and methods.

Environmental control networks or building automation systems are employed in office buildings, manufacturing facilities, and the like, for controlling the internal environment of the facility. The environment control network may be employed to control temperature, fluid flow, humidity, lighting, boilers, or chillers in the internal environment.

For example, a large warehouse may have several roof top units regulating space temperatures. The roof top units may be on multiple control loops, each control loop affecting the environment of a different warehouse zone. Certain control loops may be in a heating mode. Other control loops may be in a cooling mode. One control loop may begin oscillating between a heating mode and a cooling mode, which may cause at least a portion of other control loops to begin oscillating between a heating mode and a cooling mode.

In another example, an environment control network may be configured to control temperature and air flow. The controlled air is provided at a particular temperature or humidity so that a comfortable internal environment is established. The controlled air units (variable air volume (VAV) boxes or unitary devices) are located throughout the facility and provide environmentally controlled air to the internal environment. Similarly, some of the controlled air units may be in a heating mode and others in a cooling mode. One controlled air unit may start oscillating between a heating mode and a cooling mode, causing other controlled air units to oscillate between a heating mode and a cooling mode.

VAV boxes are coupled to an air source supplying the controlled air to the VAV box via duct work. VAV boxes and unitary devices may include a fan or other device for blowing the controlled air. VAV boxes and unitary devices provide the controlled air through a damper. The damper regulates the amount of the controlled air provided to the internal environment. The damper is coupled to an actuator which positions the damper so that appropriate air flow (measured in cubic feet per minute (CFM)) is provided to the internal environment.

A digital controller is generally associated with at least one actuator and damper. The controller may receive information related to the air flow and temperature in the internal environment and appropriately positions the actuator so that the appropriate air flow is provided to the internal environment. The controller may include feedback mechanisms such as proportional integral derivative (PID) control algorithms.

Temperature control (and other building system control) is often carried out using single-input single-output (SISO) control loops with each zone having a separate setpoint and temperature sensor. However, adjacent zones may interact due to intrazonal airflow, heat transfer, or zone-to-zone relationships. The performance of SISO control deteriorates when such interactions are present, causing oscillation and accompanying energy, comfort, and wear and tear penalties to performance. Multivariable controllers are sometimes used to control interacting loops.

### SUMMARY

The invention relates to a method for maintaining a first climate control setpoint for a first building zone having an environment that is effected by a second building zone's environment. The method includes the steps of providing the first climate control setpoint to a first control loop configured to control the environment of the first building zone. The method further includes providing a second climate control setpoint to a second control loop configured to control the environment of the second building zone. The method yet further includes receiving information about the actual climate of the first building zone and the actual climate of the second building zone; and modifying the first climate control setpoint and the second climate control setpoint to compensate for interaction between the first control loop and the second control loop.

The invention also relates to a system for maintaining a climate control setpoint for a first building zone having a climate that is effected by a second building zone's climate. The system includes a first control loop configured to control the first building zone and a second control loop configured to control the second building zone. The system yet further includes a supervisory controller configured to receive information about the actual climate of the first building zone and the second building zone and to associate a previous climate control setpoint for the first building zone and a previous climate control setpoint for the second building zone with the information about the actual climate of the first building zone. The supervisory controller is configured to calculate a new climate control setpoint for the first building zone and a new climate control setpoint for the second building zone based on the information about the actual climate of the first building zone and the second building zone and the previous setpoints of the control loops, and wherein the supervisory controller is configured to provide the new climate control setpoint to the first control loop and the second control loop.

The invention further relates to a method for maintaining a first climate control setpoint for a first building zone having a climate that is effected by a second building zone's climate. The method includes the step of providing the first climate control setpoint to a first control loop configured to control the climate of the first building zone. The method further includes providing a second climate control setpoint to a second control loop configured to control the climate of the second building zone and observing the behavior of the climate of the first building zone relative to the first climate control setpoint and the second climate control setpoint. The method yet further includes sending a new first climate control setpoint to the first control loop and a new second climate control setpoint to the second control loop. The new first climate control setpoint and the new second climate control setpoint are determined based on the observation.

The invention yet further relates to a method for maintaining a target temperature of a first building zone using a first single-input single-output (SISO) control loop and for maintaining a target temperature of a second building zone using a second SISO control loop. The method includes using a supervisory controller to adjust the inputs to the first SISO control loop and the second SISO control loop to account for interactions between the first SISO control loop and the second SISO control loop, the adjustment based on the target temperatures.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a building having a plurality of devices, according to an exemplary embodiment;

FIG. 2 is a perspective view of a building with an HVAC system, according to an exemplary embodiment;

FIG. 3 is a side view of the sub-regions of an environment control system, according to an exemplary embodiment;

FIG. 4 is a block diagram of an environmental control system, according to an exemplary embodiment;

FIG. 5 is a more detailed block diagram of the controller and VAV box of FIG. 4, according to an exemplary embodiment;

FIG. 6A is a more detailed block diagram of a controller of FIG. 4, according to an exemplary embodiment;

FIG. 6B is a more detailed block diagram of the supervisory controller of FIG. 4, according to an exemplary embodiment;

FIG. 7A is an illustration of two single-input single-output control loops at a first time period, according to an exemplary embodiment;

FIG. 7B is an illustration of two single-input single-output control loops at a future time period, according to another exemplary embodiment;

FIG. 8 is a flow diagram of a process for simulating a multivariable strategy by utilizing a supervisory controller to override local control loop setpoints, according to an exemplary embodiment; and

FIG. 9 is a detailed flow diagram of a process for simulating a multivariable strategy by utilizing a supervisory controller to override local control loop setpoints, according to an exemplary embodiment.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, a supervisory controller is configured to adjust the inputs to a first SISO control loop and a second SISO control loop to account for interactions between the first SISO control loop and the second SISO control loop.

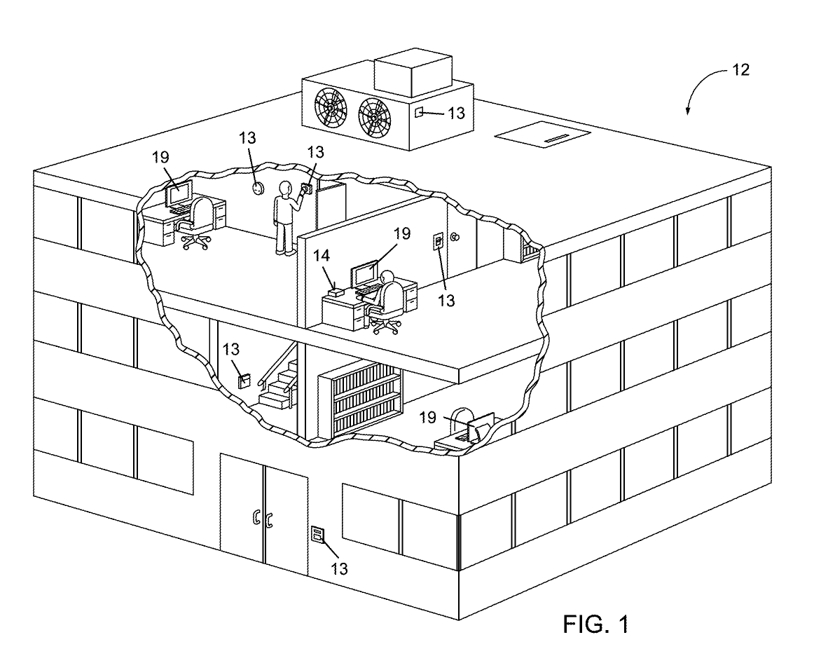

FIG. 1 is a perspective view of a building 12 having a plurality of building devices 13. As illustrated, building 12 may include any number of floors, rooms, spaces, zones, and/or other building structures and areas. According to various exemplary embodiments, building 12 may be any area of any size or type, including an outdoor area. Building 12 may include control elements such as valves, dampers, actuators, any combination thereof, or other building devices for affecting the climate (e.g., environment, temperature, humidity, air composition, etc.) of a room or a zone. Once such control element may be an air handling unit (AHU) that is part of a heating, ventilation, and air conditioning (HVAC) system which controls an environment of building 12. Building devices 13 may also exist inside or outside the building, on walls or on desks, be user interactive or not, and may be any type of device. For example, devices 13 may be a security device, a light switch, a fan actuator, a temperature sensor, a thermostat, a smoke detector, an occupancy sensor, other various types of sensors (flow, pressure, etc.), etc. Devices 13 may be configured to conduct building automation functions (e.g., sense temperature, sense humidity, control a building automation device, etc.). Devices 13 may also serve any number of network functions (e.g., RF measuring functions, network routing functions, etc.). Controller system 14 may serve as a supervisory controller for a plurality of devices 13. A workstation 19 is shown as a personal workstation. Workstation 19 may allow building engineers to interact with controller system 14. Devices 13 may be connected to controller system 14 and/or workstations 19 via a wired and/or wireless connection.

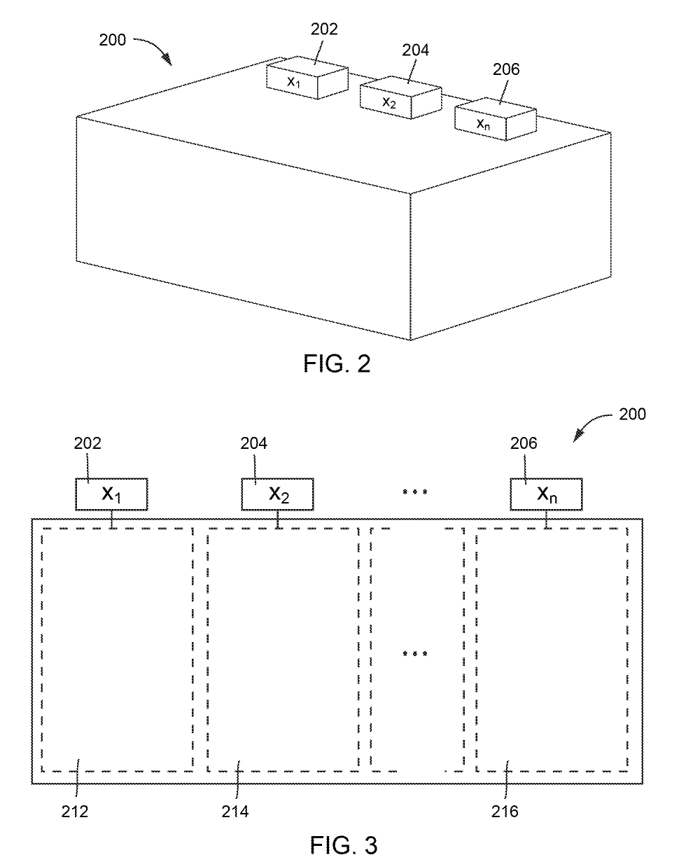

Referring to FIGS. 2 and 3, building 200 (e.g., a warehouse) is shown with several roof top units 202, 204, 206, according to an exemplary embodiment. Roof top units 202, 204, 206 are utilized to condition, chill, heat, and/or control the environment of building 200. In the embodiment of FIG. 2, three roof top units are illustrated. According to various other exemplary embodiments, building 200 may contain more or less roof top units. Each roof top unit 202, 204, 206 may be assigned a zone (e.g., room, set of rooms, part of a room, floor, set of floors, part of a floor, etc. as illustrated in FIG. 3) of building 200 that it is configured to affect (e.g., condition, cool, heat, ventilate, etc.). Referring now to FIG. 3, a first zone 212 conditioned by roof top unit 202 is shown, according to an exemplary embodiment. Zone 212 is adjacent to zone 214 conditioned by roof top unit 204. Zone 216 is adjacent to zone Xₙ₋₁ and is conditioned by roof top unit 206. Roof top units 202, 204, 206 may each be used in one or more control loops configured to affect their respective building zones 212, 214, and 216. At least one control loop may begin to oscillate from a heating mode to a cooling mode and may cause one or more of the other control loops to start oscillating.

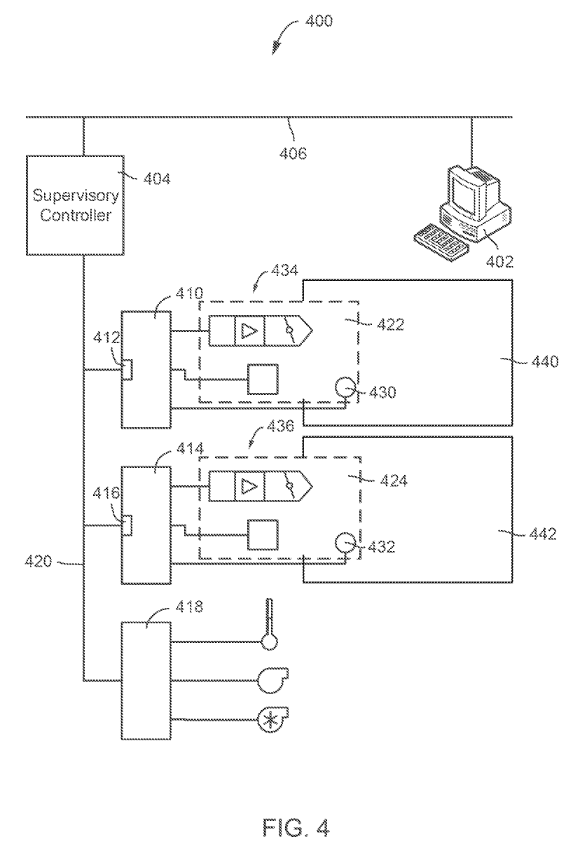

Referring to FIG. 4, a block diagram of an environment control system 400 is shown, according to an exemplary embodiment. Environment control system 400 includes a workstation 402, a supervisory controller 404 (e.g., a network automation engine (NAE)), and a plurality of controllers 410, 414, 418, (e.g., local controllers, SISO controllers, etc.) according to an exemplary embodiment. Controllers 410, 414, 418 are coupled to supervisory controller 404 via communications link 420. Workstation 402 and supervisory controller 404 are coupled via a communications bus 406. Communications bus 406 may be coupled to additional sections or additional controllers, as well as other components utilized in environment control system 400. Environment control system 400 may be a building automation system such as a METASYS® brand system manufactured by Johnson Controls, Inc. According to other exemplary embodiments, system 400 may be a unitary system having a roof top unit or another damper system.

In an exemplary embodiment, controller 410 is operatively associated with a controlled air unit such as VAV box 422 and a temperature sensor 430. Controller 414 is operatively associated with a controlled air unit such as VAV box 424 and a temperature sensor 432. System 400 may further include a controller 418 and/or other controllers operatively associated with other components of the facility. Control loops 434 and 436 are shown for VAV boxes 422, 424. VAV boxes 422 and 424 may control the environments of zones 440 and 442, respectively.

Controller 410 communicates with workstation 402 via communications link 420 through supervisory controller 404 and communications bus 406. Supervisory controller 404 may be configured to multiplex data over communications link 420 to communications bus 406. Supervisory controller 404 receives data on communications link 420, provides data to communications bus 406, receives data on communications bus 406, and provides data to communications link 420. Supervisory controller 404 is capable of other functions useful in control system 400. According to various exemplary embodiments, workstation 402 may be a personal computer, a mobile computing device (i.e., portable computer, personal digital assistant), or any other computing device. Controllers 410, 414 include a communications port 412, 416.

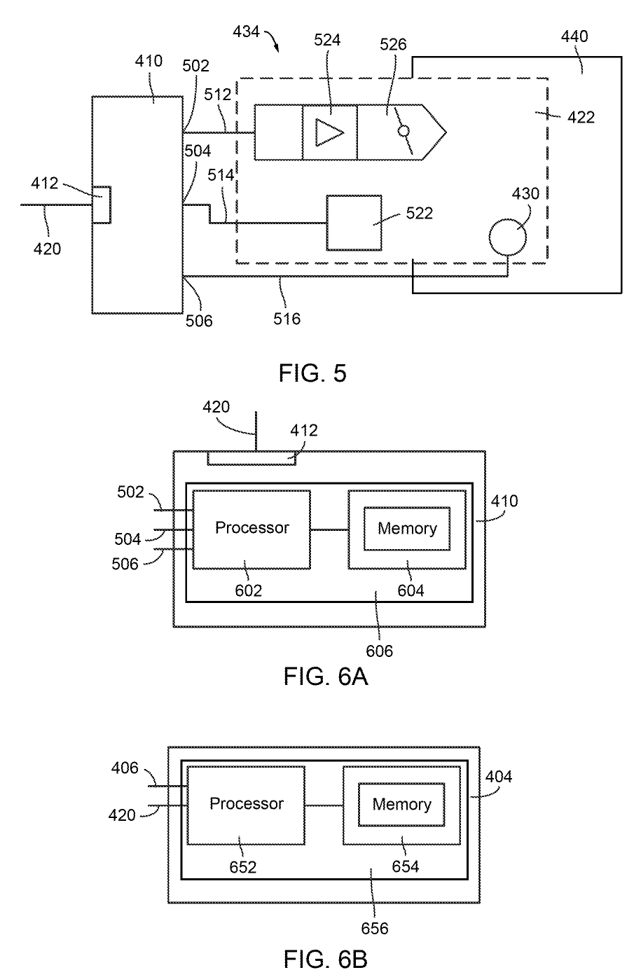

Referring to FIG. 5, a more detailed block diagram of controller 410 and VAV box 422 of FIG. 4 is shown, according to an exemplary embodiment. Control loop 434 is shown to include VAV box 422 and other components associated with loop 434. According to one exemplary embodiment, controller 410 is a direct digital control (DDC). Controller 410 is shown to include a communications port 412 coupled with communications link 420. Control loop 434 is shown to include air flow input 502, actuator output 504, and temperature sensor input 506. VAV box 422 may additionally include fans, heating or cooling elements, exhaust dampers, and return dampers for treating an air flow. Inputs 502, 506 may be analog and/or digital inputs received by an A/D converter (and/or D/A converter) in controller 410. Controller 410 includes circuitry and software for conditioning and interpreting the signals on inputs 502, 506 (illustrated by processor 602 of FIG. 6A).

In an exemplary embodiment, VAV control box 422 includes a damper 526, an air flow sensor 524, and an actuator 522. Actuator 522 positions damper 526 and may be an electric motor based actuator. Alternatively, actuator 522 and controller 410 may be pneumatic or any other type of device for controlling and positioning damper 526. In an exemplary embodiment, actuator 522 is a motor driven actuator having a full stroke time of 1, 2, or 5.5 minutes for a 90 degree stroke.

In an exemplary embodiment, the position of damper 526 controls the amount of air flow provided to a zone 440 (e.g., a room, hallway, building, a portion thereof, or other internal environment). Air flow sensor 524 provides a parameter such as an air flow parameter across conductor 512 to air flow input 502. The air flow parameter represents the amount of air flow provided through damper 526 to an environment. According to an exemplary embodiment, air flow sensor 524 may be a differential pressure sensor which provides a sensed value or factor related to air flow (e.g., volume/unit time, CFM air flow).

Controller 410 provides an actuator output signal to actuator 522 from actuator output 504 via a conductor 514. Controller 410 receives a temperature signal (or other type of signal) from a temperature sensor 430 (or other type of sensor) across a conductor 516 at temperature input 506. Temperature sensor 430 may be a resistive sensor located in an environment.

According to an exemplary embodiment, controller 410 is configured to appropriately position actuator 522 in accordance with an executed control algorithm. In an exemplary embodiment, the control algorithm is an integral (I), a proportional (P), proportional integral (PI), a proportional derivative (PD), a proportional-integral derivative (PID), any feedback logic control algorithm, or any combination thereof that is configured to achieve and/or maintain a setpoint (e.g., temperature setpoint, humidity setpoint, etc.) provided to controller 410 via supervisory controller 404.

In accordance with a control algorithm, at every cycle controller 410 receives the air flow value at input 502, the temperature value at input 506, and other data (e.g., a setpoint) from communications link 420 at port 412. Controller 410 provides the actuator output signal at the actuator output 504 every cycle to accurately position damper 526 so that environment is appropriately controlled (heated, cooled, or otherwise conditioned). Thus, controller 410 cyclically responds to the air flow value and the temperature value and cyclically provides the actuator output signal 504 to appropriately control the internal environment. In an exemplary embodiment, the system may utilize temperature, humidity, flow rate, pressure, industrial system characteristics, or other feedback loop data. The actuator output signals may be pulse width signals, which cause actuator 522 to move forward, backward, or stay in the same position, and controller 410 internally keeps track of the position of actuator 522 as it is moved. Alternatively, actuator 522 may provide feedback indicative of its position, or the actuator signal may indicate the particular position to which actuator 522 should be moved.

According to an exemplary embodiment, control loops 434, 436 are single-input single-output (SISO) in that they receive a setpoint from the supervisory controller and provide an output configured to affect a building environment. The local control loop of controllers 410, 416 may consider any number of variables and feedback data but does so without receiving information from another control loop (e.g., controller 412 does not receive and use information about control loop 436 or controller 416 in its control strategy).

Referring to FIG. 6A, a more detailed block diagram of controller 410 is shown, according to an exemplary embodiment. Controller 410 is shown to include a processing circuit 606. Processing circuit is shown to include processor 602 and memory 604. Processing circuit 606 may be communicably coupled with air flow input 502, actuator output 504, temperature input 506, and communications port 412. According to various exemplary embodiments, processing circuit 606 may be a general purpose processor, an application specific processor, a circuit containing one or more processing components, a group of distributed processing components, a group of distributed computers configured for processing, etc. Processor 602 may be or include any number of components for conducting data processing and/or signal processing.

Memory 604 (e.g., memory unit, memory device, storage device, etc.) may be one or more devices for storing data and/or computer code for completing and/or facilitating the various processes described in the present disclosure. Memory 604 may include a volatile memory and/or a non-volatile memory. Memory 604 may include database components, object code components, script components, and/or any other type of information structure for supporting the various activities described in the present disclosure. According to an exemplary embodiment, any distributed and/or local memory device of the past, present, or future may be utilized with the systems and methods of this disclosure. According to an exemplary embodiment, memory 604 is communicably connected to processor 602 (e.g., via a circuit or other connection) and includes computer code for executing one or more processes described herein. Memory 604 may include various data regarding the operation of a control loop (e.g., previous setpoints, previous behavior patterns regarding energy used to adjust a current value to a setpoint, etc.).

Referring to FIG. 6B, a more detailed block diagram of supervisory controller 404 is shown, according to an exemplary embodiment. Supervisory controller 404 includes a processing circuit 656 that includes a processor 652 and memory 654. Processing circuit 656, processor 652, and memory 654 may have the same general function as described with respect to processing circuit 606, processor 602, and memory 604 of FIG. 6A. Supervisory controller 404 is coupled to a communications bus 406 and communications link 420 for communicating between various controllers and a workstation. According to an exemplary embodiment, processing circuit 656 is configured to facilitate and/or execute the control algorithms for controlling controller 410 and controller 414. Supervisory controller 404 may be configured to store setpoints in memory 654. The setpoints may be set or determined based on user input (e.g., received from a client system, a local user interface, etc.), a setpoint schedule, and/or one or more functions. It is important to note that a supervisory controller may be any controller upstream of controllers 410 and 414, including, for example, workstation 402. According to various exemplary embodiments supervisory controller 404 may be distributed so that some components for supervisory controller 404 are provided in one physical computing device and other components are provided in other computing devices (e.g., remote computing devices, remote servers, etc.). It should be appreciated that supervisory controller 404 may also be implemented within controllers 410, 414 or their respective control loops and behave as a virtual supervisory controller configured to supervise (e.g., provide control signals to) multiple control loops.

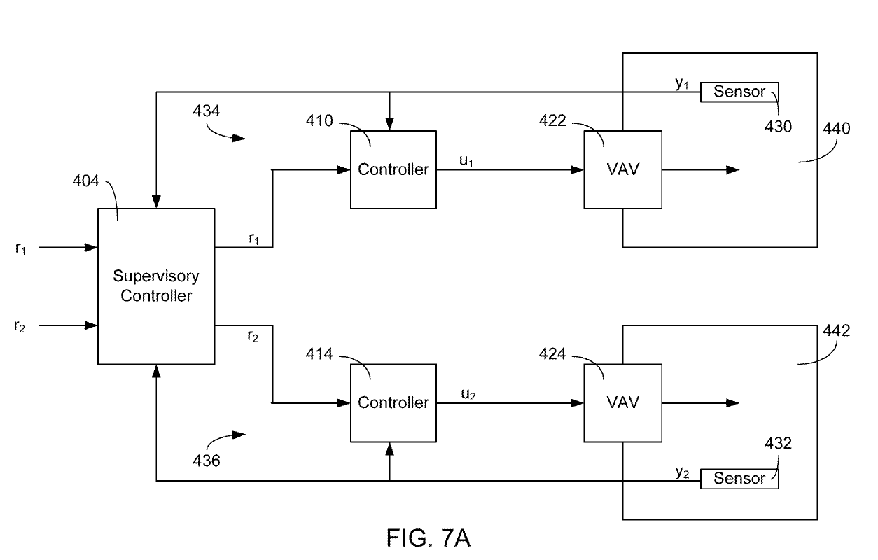

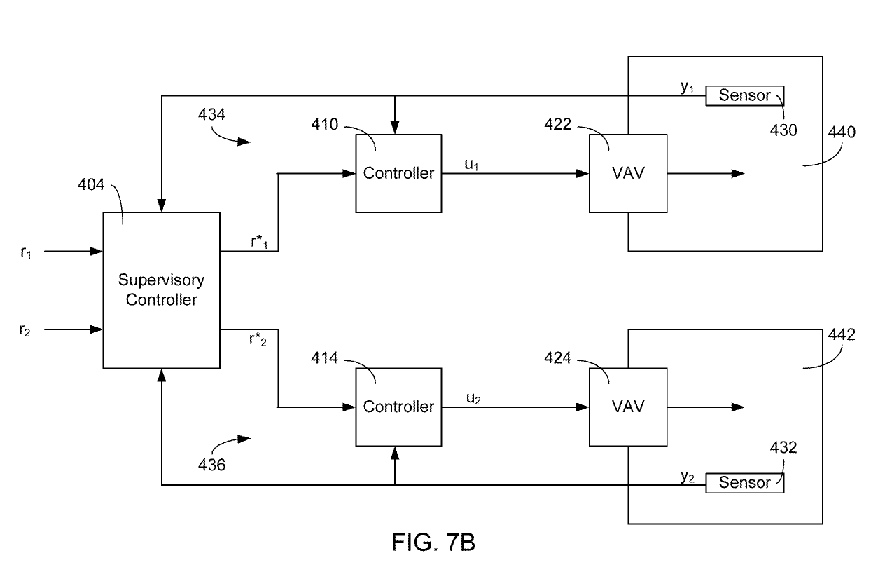

Referring to FIGS. 7A-B, an illustration of two control loops 434, 436 is shown, according to an exemplary embodiment. Each control loop 434, 436 includes a controller 410, 414, a VAV box 422, 424, and a sensor 430, 432. According to one exemplary embodiment, loops 434, 436 may be used to control temperature targets (e.g., setpoints) for building zones 440, 442 provided to the loops by supervisory controller 404. According to other exemplary embodiments, loops 434, 436 may be used to control a flow (e.g., from a chiller or boiler), humidity, or other building setting.

Supervisory controller 404 accepts an actual value or output y₁ and y₂ from sensors 430, 432 (e.g., a temperature sensor reading) along with a desired target or setpoint for y₁ and y₂ (r₁ and r₂). Supervisory controller 404 processes the inputs and provides an output to controllers 410, 414. In the embodiment of FIG. 7A, the outputs from supervisory controller 404 to controllers 410 and 414 are the desired setpoints r₁, r₂. In the embodiment of FIG. 7B, the outputs from supervisory controller 404 to controllers 410 and 414 are modified setpoints r₁*, r₂*. Controllers 410, 414 receive input in the form of sensor information y₁ and y₂ and use the input to attempt to achieve and/or maintain the setpoint (r₁, r₂ in a first period of time, r₁*, r₂* in one or more future periods of time) provided by supervisory controller 404 by controlling VAV boxes 422, 424.

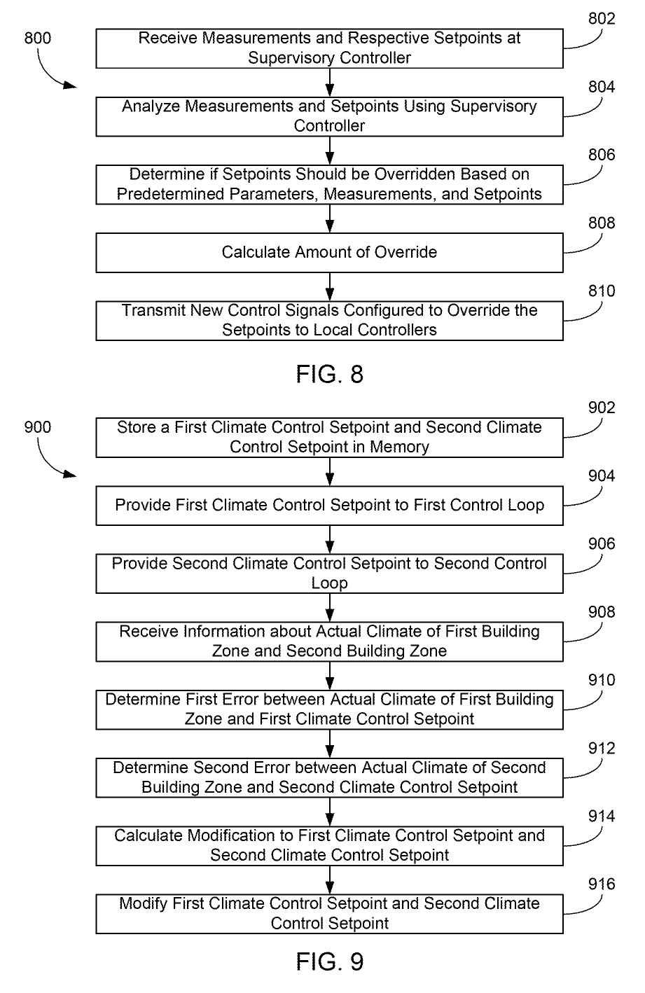

Referring to FIG. 8, a flow diagram of a process 800 for achieving and/or maintaining climate control setpoints for a building zone having an environment that is affected by a second building zone's environment is shown. The system and/or the loops may be initiated via any number of activities (e.g., an initial user setting, a default setting, etc.). In an exemplary embodiment, the system may be initiated automatically based on predetermined time intervals or system performance characteristics, via input devices, via audio commands, or any combination thereof. The initiation process may include setting and storing intended setpoints (e.g., temperature targets) for the zones in the supervisory controller. The intended setpoints may then be sent to the control loops from the supervisory controller.

Process 800 is shown to include receiving measurements from the temperature sensors of the control loops and accessing setpoints for the control loops (step 802). The measurements and setpoints are then analyzed using the supervisory controller (step 804). Based on the analysis, the system may determine if setpoints should be overridden based on predetermined parameters, the measurements and/or the setpoints (step 806). An amount of the override may then be calculated (step 808) and new control signals configured to override the setpoints that would otherwise be transmitted to the local controllers are transmitted (step 810). The determination regarding whether the setpoints should be overridden may be based on knowledge that the local control loops are not obtaining the temperatures commanded by the setpoints provided to the local control loops. The determination may also (or alternatively) be based on a result of the analysis step (step 804) that indicates that one or more control loops are interacting. The calculation of step (step 808) may include using the observed behavior for the zones and control loops (e.g., the received measurements) in combination with knowledge of the target setpoint. The calculation may further include solving for the amount of override estimated to be necessary to compensate for the interaction (or “coupling”) determined to exist between the zones/control loops.

Referring more specifically to step 808 of process 800, the calculation is used to modify the first climate control setpoint r₁ and the second climate control setpoint r₂ to compensate for interaction between the first control loop and the second control loop. The calculation may be based on one or more matrix-based functions configured to solve for multiple variables.

In FIG. 7A, the system is shown as operating in a first period of time during which supervisory controller 404 sends the original setpoints r₁, r₂ to controller 410 and controller 414. Supervisory controller 404 accepts inputs y₁, y₂ from sensors 430, 432 and the original setpoints r₁, r₂. During a subsequent period of time the system provides modified setpoints r₁*, r₂* from supervisory controller 404 to controllers 410 and 414.

In an exemplary embodiment, the original setpoints (r₁ and r₂) and the outputs of controllers 410, 414 (u₁ and u₂) and sensors 430, 432 (y₁ and y₂) may be defined in a matrix form:

$$r = [ \begin{matrix}{r}_{1} \\ {r}_{2}\end{matrix} ] , \\ u = [ \begin{matrix}{u}_{1} \\ {u}_{2}\end{matrix} ] ;$$

$$y = [ \begin{matrix}{y}_{1} \\ {y}_{2}\end{matrix} ] .$$

Similarly, the plant transfer function for a plant P (e.g., VAV box 422) may be defined in matrix form as:

$$P = [ \begin{matrix}P 1 & P 12 \\ P 21 & P 2\end{matrix} ] .$$

In an exemplary embodiment, y=u^{T}P may be assumed (the output of the plant is a byproduct of the input and transfer function of the plant). Therefore, the effect of an interaction between two loops is dependent upon the values of P12 and P21 (e.g., values to represent the interaction between the two loops, while the values of P1 and P2 represent interactions within the first loop and second loop, respectively).

In an exemplary embodiment, control system C (e.g., the control system including controllers 410 and 414) may be defined in matrix form as:

$$C = [ \begin{matrix}{λ}_{1} C 1 & {λ}_{3} C 2 \\ {λ}_{2} C 1 & {λ}_{4} C 2\end{matrix} ] .$$

The elements in C may be designed based on the full plant transfer function P. λ₁ through λ₄ are factors quantifying the effect of the control loops (e.g., loops 434, 436) of the system on the zones of the system (e.g., zones 440, 442).

λ₁ through λ₄ may be scalars, according to an exemplary embodiment. According to other exemplary embodiments, λ₁ through λ₄ may be a transfer function with dynamics, or any other constant or function. The estimation of λ₁ through λ₄ may be implemented or otherwise accomplished in various ways. According to one exemplary embodiment, observation histories (e.g., observations of the effect changes in one control loop have on another zone) may be used to determine values or functions for λ₁ through λ₄. For example, the system may use historical errors between setpoints and measured values in combination with λ₁ through λ₄ to compute new setpoints.

According to an exemplary embodiment, error input vector e may represent the difference between the desired setpoints r₁ and r₂ and measured values y₁ and y₂ (e.g., e₁=r₁−y₁ and e₂=r₂-y₂). Error input vector (error signals) e may be defined in matrix form as:

$$e = [ \begin{matrix}{e}_{1} \\ {e}_{2}\end{matrix} ] .$$

Using error input vector e and defined controller matrix C, u (e.g., the corrected output from the local controllers to the plants) may be defined in matrix form as u=e^{T}C. Therefore, u₁=(e₁λ₁+e₂λ₂)C1 and u₂=(e₁λ₃+e₂λ₄)C2.

Rather than continuing to use r₁ in controller 410 or r₂ in controller 414, supervisory controller 404 may be configured to override original setpoints r₁ and r₂ with adjusted setpoints r₁ and r₂ to compensate for the interaction between the two control loops.

According to an exemplary embodiment, r₁* and r₂* may be defined as follows:

r₁*=e₁λ₁+e₂λ₂+y₁

r₂*=e₁λ₃+e₂λ₄+y₂.

The supervisory controller may then adjust setpoints r₁, r₂ provided to the SISO controllers with r₁*, r₂*. The setpoints are therefore adjusted to account for interaction between control loops. Thereafter, new setpoints are created using values and functions associated with old measurements and old setpoints (e.g., the last measurement and last setpoint of the previous sample period). Process 800 may continually repeat to constantly adjust the setpoints until an equilibrium is reached, according to an exemplary embodiment.

Referring to FIG. 9, a detailed flow chart of a process 900 for achieving and/or maintaining a first climate control setpoint for a first building zone having an environment that is affected by a second building zone's environment is shown, according to an exemplary embodiment. Process 900 is shown to include storing the first climate control setpoint and a second climate control setpoint in memory (step 902). The stored setpoints may be target setpoints (e.g., target temperatures) that are maintained as targets or objectives throughout process 900. Process 900 is further shown to include providing the first climate control setpoint to a first control loop configured to control the environment of the first building zone (step 904) and providing a second climate control setpoint to a second control loop configured to control the environment of the second building zone (step 906).

According to the exemplary embodiment illustrated in FIG. 9, process 900 is further shown to include receiving information about the actual climate of the first building zone (e.g., as measured by a sensor within the first building zone) and the actual climate of the second building zone (e.g., as measured by a sensor within the second building zone) (step 908). The received information about the actual climate of the first building zone and the actual climate of the second building zone are then used to determine a first error between the actual climate of the first building zone and the first climate control setpoint (step 910) and a second error between the actual climate of the second building zone and the second climate control setpoint (step 912). Process 900 is further shown to include calculating a modification for the first climate control setpoint and the second climate control setpoint (step 914). As described above, the modification may be based on the first error, the second error, the contribution of the second control loop to the first error, and the contribution of the first control loop to the second error. The modification may be configured to compensate for interaction between the first control loop and the second control loop. Process 900 includes modifying the first climate control setpoint and the second climate control setpoint (step 916) (e.g., transmitting overriding setpoints to the first and second control loops). Calculating of the amount of the modification (step 914) for the first climate control setpoint and the second climate control setpoint may also be based on the contribution of the first control loop to the first error and the contribution of the second control loop to the second error. The modification may be based on a calculation configured to achieve the first climate control setpoint previously stored in the supervisory controller in some future period of time and to achieve the previously stored second climate control setpoint in the future period of time.

While the exemplary embodiments illustrated in the figures and described herein are presently preferred, it should be understood that the embodiments are offered by way of example only. Accordingly, the present application is not limited to a particular embodiment, but extends to various modifications that nevertheless fall within the scope of the appended claims.

The systems shown in the figures may include wired communication links and/or wireless communications links for communication between components and/or with remote sources. The wireless links may be formed according to a Bluetooth communications protocol, an IEEE 802.11 protocol, an IEEE 802.16 protocol, a cellular signal, a Shared Wireless Access Protocol-Cord Access (SWAP-CA) protocol, a wireless USB protocol, or any other suitable wireless technology. Wired links may be established via Ethernet, USB technology, IEEE 1394 technology, optical technology, other serial or parallel port technology, or any other suitable wired link.

In an exemplary embodiment, the system can be utilized with AHUs. In an exemplary embodiment, the AHUs may have water-to-air heat exchangers for providing heating and cooling to an air stream. The flow of water through the coils is regulated by a hydronic valve, which is moved by an electric actuator connected to a controller. The valve position is adjusted to maintain the air temperature exiting the heat exchangers to a target condition (e.g., setpoint).

The present disclosure is not limited to any specific building system application. According to various exemplary embodiments, the systems and methods of the present disclosure may be extended to various building automation system applications other than a temperature control. For example, flow, humidity, and other building area properties may be controlled using the systems and methods of the present disclosure. In an exemplary embodiment, a simulated multivariable strategy is implemented by utilizing a supervisory controller to override setpoints provided to each SISO controller. In an exemplary embodiment, the system and method of utilizing supervisory controllers to override setpoints to each SISO may not require hardware and software redesigns of the local control loops (e.g., the controllers downstream of the supervisory controller).

There may be more than one supervisory controller for multiple loops, according to various exemplary embodiments. In the exemplary embodiment shown in FIGS. 7-9, the system is a 2×2 system (e.g., there are two control loops impacting each other). According to various exemplary embodiments, the system may be expanded up to an N×N system, for any number N of loops (e.g., a plurality of loops N may all impact each other loop).

The construction and arrangement of the systems and methods as shown in the various exemplary embodiments are illustrative only. Although only a few embodiments have been described in detail in this disclosure, many modifications are possible. All such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures may show a specific order of method steps, the order of the steps may differ from what is depicted. Also two or more steps may be performed concurrently or with partial concurrence. Such variations will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for maintaining a first climate control setpoint for a first building zone having an environment that is affected by a second building zone's environment, comprising:
providing the first climate control setpoint to a first control loop configured to control the environment of the first building zone;
providing a second climate control setpoint to a second control loop configured to control the environment of the second building zone;
receiving information about the actual climate of the first building zone and the actual climate of the second building zone; and
modifying the first climate control setpoint and the second climate control setpoint to compensate for interaction between the first control loop and the second control loop.

2. The method of claim 1, further comprising:
determining a first error between the actual climate of the first building zone and the first climate control setpoint and a second error between the actual climate of the second building zone and the second climate control setpoint; and
calculating the amount of the modification for the first climate control setpoint and the second climate control setpoint based on the first error, the second error, the contribution of the second control loop to the first error, and the contribution of the first control loop to the second error.

3. The method of claim 2, wherein the calculation of the amount of the modification for the first climate control setpoint and the second climate control setpoint is further based on the contribution of the first control loop to the first error and the contribution of the second control loop to the second error.

4. The method of claim 1, further comprising:
storing the first climate control setpoint in a memory device prior to modification;
storing the second climate control setpoint in the memory device prior to modification; and wherein the modification is based on a calculation configured achieve the stored first climate control setpoint in a future period of time and to achieve the stored second climate control setpoint in the future period of time.

5. A system for maintaining a climate control setpoint for a first building zone having a climate that is affected by a second building zone's climate, comprising:
a first control loop configured to control the first environment of the building zone;
a second control loop configured to control the second environment of the building zone; and
a supervisory controller configured to receive information about the actual climate of the first building zone and the second building zone and to associate a previous climate control setpoint for the first building zone and a previous climate control setpoint for the second building zone with the information about the actual climate of the first building zone;
wherein the supervisory controller is configured to calculate a new climate control setpoint for the first building zone and a new climate control setpoint for the second building zone based on the information about the actual climate of the first building zone and the second building zone and the previous setpoints of the control loops, and wherein the supervisory controller is configured to provide the new climate control setpoint to the first control loop and the second control loop.

6. The system of claim 5, wherein the first control loop is a single-input single-output (SISO) control loop.

7. The system of claim 6, wherein the second control loop is a SISO control loop.

8. A method for maintaining a first climate control setpoint for a first building zone having a climate that is affected by a second building zone's climate, comprising:
providing the first climate control setpoint to a first control loop configured to control the climate of the first building zone;
providing a second climate control setpoint to a second control loop configured to control the climate of the second building zone;
observing the behavior of the climate of the first building zone relative to the first climate control setpoint and the second climate control setpoint; and
sending a new first climate control setpoint to the first control loop and a new second climate control setpoint to the second control loop;
wherein the new first climate control setpoint and the new second climate control setpoint are determined based on the observation.

9. The method of claim 8, wherein the new first climate control setpoint and the new second climate control setpoint are calculated to compensate for determined interaction between the first control loop and the second control loop.

10. The method of claim 8, wherein the first control loop is a single-input and single-output (SISO) control loop.

11. The method of claim 10, wherein the second control loop is a single-input and single-output (SISO) control loop.

12. A supervisory controller configured to simulate a multi-variable climate control loop for a building zone by adjusting a first control signal to a first single-input single-output (SISO) control loop associated with the building zone and a second control signal to a SISO control loop associated with an nearby building zone, the building zone having a first sensor for measuring the climate variable intended to be controlled by the first SISO control loop and the adjacent building zone having a second sensor for measuring the climate variable intended to be controlled by the second control loop, supervisory controller comprising:
a processing circuit configured to:
read a target setpoint for the climate variable intended to be controlled by the first SISO control loop;
send the first control signal to the first SISO control loop;
send the second control signal to the second SISO control loop;
receive signals from the first sensor and second sensor;
calculate an adjustment to the first control signal and an adjustment to the second control signal, the adjustments based on the signals from the first sensor and the second sensor and the first control signal and the second control signal;
provide an adjusted first control signal to the first SISO control loop; and
provide an adjusted second control signal to the second SISO control loop.

13. The supervisory controller of claim 12, wherein the processing circuit comprises a processor and memory communicably coupled to the processor, the memory comprising computer code for completing the calculation.

14. The supervisory controller of claim 12, wherein the first sensor and the second sensor are one of temperature sensors or humidity sensors.

15. The supervisory controller of claim 12, wherein the first SISO control loop comprises a variable air volume box and a local controller for the variable air volume box, the local controller configured to the adjust the variable air volume box to maintain the setpoint commanded by the first control signal.

16. The supervisory controller of claim 15, wherein the second SISO control loop comprises a variable air volume box and a local controller for the variable air volume box, the local controller configured to the adjust the variable air volume box to maintain the setpoint commanded by the second control signal.

17. The supervisory controller of claim 12, wherein the calculation includes a function configured to compensate for the effect of the second SISO control loop on the first SISO control loop.

18. The supervisory controller of claim 17, wherein the function is further configured to compensate for the effect of the first SISO control loop on the second SISO control loop.

19. The supervisory controller of claim 12, wherein the supervisory controller is part of the first SISO control loop, the second SISO control loop, or a part of the first SISO control loop and the second SISO control loop.

20. The supervisory controller of claim 12, wherein the supervisory controller is a computer system upstream of the first SISO control loop and the second SISO control loop.

21. The supervisory controller of claim 12, wherein the supervisory controller is a system of distributed computing components.

22. A method for maintaining a first condition at a first target for the first condition using a first single-input single-output (SISO) control loop and for maintaining a second condition at a second target for the second condition using a second SISO control loop, the method comprising:
using a supervisory controller to adjust the inputs to the first SISO control loop and the second SISO control loop to account for interactions between the first SISO control loop and the second SISO control loop, the adjustment based on the targets.

23. The method of claim 22, wherein the inputs to the first SISO control loop and the second SISO control loop are setpoints stored in memory of the supervisory controller.
